(19) United States
(12) Patent Application Publication
(10) Pub. No.: US 2005/0244143 A1
(43) Pub. Date: Nov. 3, 2005

(54) Information reproducing apparatus and information reproducing method

(75) Inventor: Hiroaki Ito, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/115,262

(22) Filed: Apr. 27, 2005

(30) Foreign Application Priority Data
Apr. 28, 2004 (JP) 2004-134665

(51) Int. Cl. H04N 5/781

(52) U.S. Cl. 386/125; 386/126

(57) ABSTRACT

Disclosed is an information reproducing apparatus including a command input part inputting a common command for reproducing a video manager menu or a video title set menu; a detecting part which detects existence information of the video manager menu and existence information of the video title set menu from information read from the information recording medium; and a menu reproducing part which reproduces, in precedence, a predetermined menu that is found recorded based on the detected existence information, out of the video manager menu and the video title set menu, when the common command is inputted from the command input part.

### CROSS-REFERENCE TO THE INVENTION

This application is based upon and claims the benefit of priority from the prior Japanese Patent Application No. 2004-134665, filed on Apr. 28, 2004; the entire contents of which are incorporated herein by reference.

### BACKGROUND

1. Field of the Invention

The present invention relates to an information reproducing apparatus and an information reproducing method for reproducing information from an information recording medium such as a DVD (Digital Versatile Disc), and more particularly, to an information reproducing apparatus and an information reproducing method capable of reproducing a video manager menu and a digital title set menu based on existence information of these menus recorded on an information recording medium.

2. Description of the Related Art

In a DVD disc, several menus such as a root menu and a title menu (information other than information corresponding to main contents) are sometimes recorded. In response to a user's operation for menu call and reproduction, a current operation state is changed to display of a list of all callable menus. Upon user's selection of a menu that meets the operation purpose of the user from the displayed menu list, the contents of the selected menu is displayed, and it is not until this time that the user can select a desired item in the selected menu (see, for example, Patent document 1).

Japanese Patent Laid-open Application No. 2001-312880 (paragraphs 0055 to 0070, FIGS. 12, 13).

In the above-described conventional example, the user has to perform totally at least two operations, i.e., menu list call and menu selection from the list before calling the intended menu. Moreover, for displaying reduced individual menus simultaneously on a screen as the menu list, a function of reducing the menus is required, which accordingly increases the scale of firmware.

### SUMMARY

In consideration of such circumstances, it is an object of the present invention to provide an information reproducing apparatus and an information reproducing method which are capable of reproducing a preset menu in precedence out of a video manager menu and a video title set menu with one operation, thereby realizing improved operability.

An information reproducing apparatus according to an aspect of the present invention is an information reproducing apparatus that reproduces information from an information recording medium in which information including a video manager menu and a video title set menu is recorded, the information reproducing apparatus including: a command input part inputting a common command for reproducing the video manager menu or the video title set menu; a detecting part which detects existence information of the video manager menu and existence information of the video title set menu from information read from the information recording medium; and a menu reproducing part which reproduces, in precedence, a predetermined menu that is found recorded based on the detected existence information, out of the video manager menu and the video title set menu, when the common command is inputted from the command input part.

An information reproducing method according to an aspect of the present invention is an information reproducing method of reproducing information from an information recording medium in which information including a video manager menu and a video title set menu is recorded, the information reproducing method including: inputting a common command for reproducing the video manager menu or the video title set menu; detecting existence information of the video manager menu and existence information of the video title set menu from information read from the information recording medium; and reproducing, in precedence, a predetermined menu that is found recorded based on the detected existence information, out of the video manager menu and the video title set menu, when the common command is inputted.

According to the information reproducing apparatus and the information reproducing method of the present invention, it is possible to reproduce a preset menu in precedence with one operation, realizing improved operability.

### BRIEF DESCRIPTION OF THE DRAWINGS

FIG. 1 is a diagram showing a logical structure of a DVD disc.

FIG. 2 is a diagram showing data structures of a video manager (VMG) and a video title set (VTS) respectively.

FIG. 3 is a block diagram showing an entire configuration of an information reproducing apparatus according to one embodiment of the present invention.

FIG. 4 is a view showing an implementation example (comparative example) of a menu call function of an external operation device used in the information reproducing apparatus shown in FIG. 3.

FIG. 5 is a view showing another implementation example of the menu call function of the external operation device used in the information reproducing apparatus shown in FIG. 3.

FIG. 6 is a view showing still another implementation example of the menu call function of the external operation device used in the information reproducing apparatus shown in FIG. 3.

FIG. 7 is a flowchart showing menu reproduction processing in the information reproducing apparatus shown in FIG. 3.

FIG. 8 is a view showing an example of a screen for setting of precedence information on menu reproduction.

FIG. 9 is a flowchart showing menu reproduction processing (another example) in the information reproducing apparatus shown in FIG. 3.

FIG. 10 is a flowchart showing menu reproduction processing (still another example) in the information reproducing apparatus shown in FIG. 3.

FIG. 11 is a flowchart showing menu reproduction processing (yet another example) in the information reproducing apparatus shown in FIG. 3.

FIG. 12 is a flowchart showing menu reproduction processing (yet another example) in the information reproducing apparatus shown in FIG. 3.

### DETAILED DESCRIPTION

(Description of Embodiments)

Embodiments of the present invention will be described with reference to the drawings, but these drawings are presented only for an illustrative purpose and in no way limit the present invention.

As a form of an embodiment of the present invention, the information reproducing apparatus may further include a setting part that sets which menu is to be reproduced in precedence out of the video manager menu and the video title set menu.

As another form, the information reproducing apparatus may further include an operation state detecting part detecting whether a current state is a stop state or not, and the menu reproducing part may reproduce the video manager menu in precedence when the operation state detecting part detects that the current state is the stop state, while reproducing the video title set menu in precedence when the operation state detecting part detects that the current state is a state other than the stop state.

Hereinafter, embodiments of the present invention will be described with reference to the drawings.

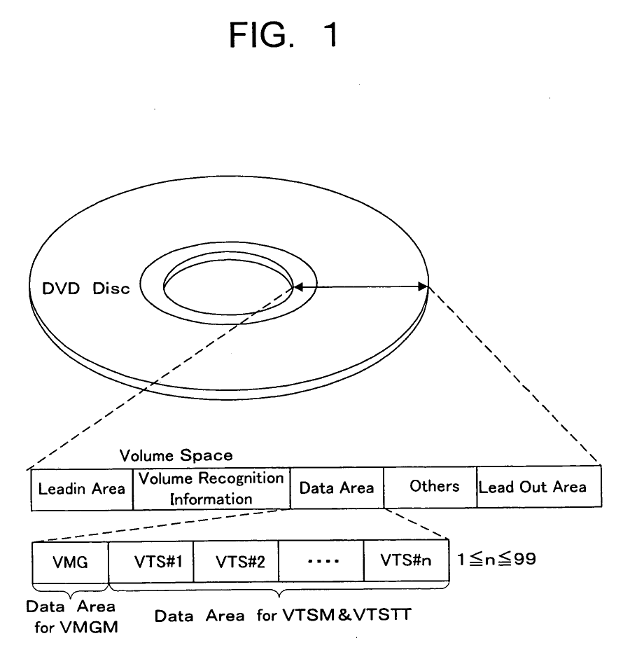

FIG. 1 shows a logical structure of a DVD disc as an information recording medium from which information is reproduced by an information reproducing apparatus according to one embodiment of the present invention.

This DVD disc is a recording medium capable of recording only one volume on its one face. DVD video contents including image/audio information and reproduction management information (control information) are written (recorded) in a Data Area, and the Data Area is further divided into a video manager (VMG) area and a video title set (VTS) area. The video title set area can record a plurality of video title sets (VTS), the maximum recordable number being 99.

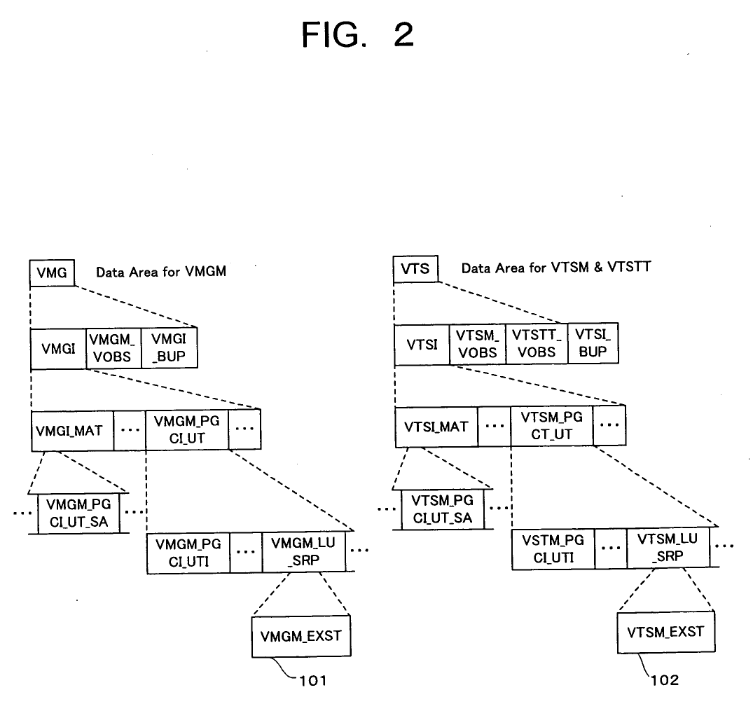

FIG. 2 shows data structures of the video manager (VMG) and the video title set (VTS) respectively.

The video manager (VMG) is composed of control information VMGI and other data (VMGM_VOBS, VMGI_BUP) and only one video manager (VMG) is recordable in one volume. The control information VMGI is information for controlling the video manager menu video object set (VMGM_VOBS) and all the video title sets (VTS) in the volume. Each of the video title sets (VTS) is composed of control information VTSI and other data (VTSM_VOBS, VTSTT_VOBS, VTSI_BUP), its maximum recordable number in one volume being 99. The control information VTSI is information for controlling the video title set menu video object set (VTSM_VOBS) and all the title data (VTSTT_VOBS) in this VTS.

The video manager menu video object set (VMGM_VOBS) of the video manager (VMG) shows video objects of VMGM (=VMGM data) but it is not always existing. In order to check the existence of reproducible video objects, a head address of a VMGM program chain information unit table is obtained from a VMGM_PGCI_UT in the control information VMGI, and video manager menu existence information (VMGM_EXST) 101 is further referred to in the VMGM_PGCI_UT, so that the existence or not of reproducible VMGM_VOBS (=corresponding to a program chain of the video manager menu) can be detected.

The video title set menu video object set (VTSM_VOBS) of the video title set (VTS) shows video objects of VTSM (=VTSM data) but it is not always existing. In order to check the existence of reproducible video objects, a head address of a VTSM program chain information unit table is obtained from the VTSM_PGCI_UT in the control information VTSI and video title set menu existence information (VTSM_EXST) 102 is further referred to in the VTSM_PGCI_UT, so that the existence or not of reproducible VTSM_VOBS (=corresponding to a program chain of the video title set menu) can be detected.

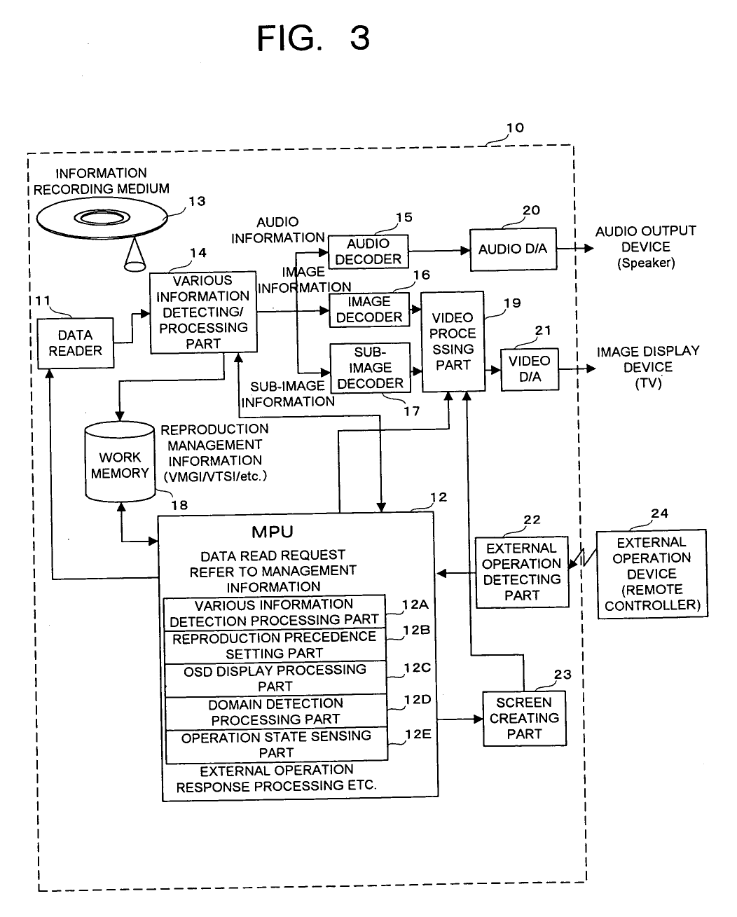

FIG. 3 is a block diagram showing an entire configuration of the information reproducing apparatus according to the embodiment of the present invention.

As shown in the drawing, this information reproducing apparatus includes a data reader 11 such as an optical disc drive, a MPU 12, a various information detecting/processing part 14, an audio decoder 15, an image decoder 16, a sub-image decoder 17, a. work memory 18, a video processing part 19, an audio D/A 20, a video D/A 21, an external operation detecting part 22 (command input part), a screen creating part 23, and so on. Among them, the various information detecting/processing part 14, the audio decoder 15, the image decoder 16, the sub-image decoder 17, the video processing part 19, the audio D/A 20, and the video D/A 21 also function as a menu reproducing part.

The MPU 12 includes a various information detection processing part 12A (detecting part), a reproduction precedence setting part 12B (setting part), an OSD (On Screen Display) display processing part 12C, a domain detection processing part 12D (domain detecting part), an operation state sensing part 12E (operation state detecting part), and so on.

The various information detection processing part 12A detects the VMGI and VTSI based on information from the various information detecting/processing part 14.

The reproduction precedence setting part 12B sets which menu is to be reproduced in precedence out of the video manager menu (VMGM) and the video title set menu (VTSM), according to the selection by the user.

Base on the information from the various information detection processing part 12A, the OSD display processing part 12C controls the screen creating part 23 that creates various selection screens including elements switchable by a user's selection.

The domain detection processing part 12D detects a domain as a reproduction target. Domains of video objects as the reproduction targets include a VMGM domain, a VTSM domain, a title domain, a first-play domain, and so on. More specifically, a reproduction target in the VMGM domain is the video object set of the video manager menu (VMGM_VOBS), a reproduction target in the VTSM domain is the video object set of the video title set menu (VTSM_VOBS), and a reproduction target in the title domain is the video title set (VTS_TT_VOBS).

The operation state sensing part 12E detects an operation state of the information reproducing apparatus.

Next, an operation for obtaining the VMGI and the VTSI in the above-described information reproducing apparatus will be described.

First, following an instruction of the MPU 12, the data reader 11 obtains data at a designated position in the Data Area on the information recording medium (DVD disc) 13. The information detecting/processing part 14 classifies the obtained data by each attribute such as audio, image, and sub-image, and each of the classified data is transferred to the audio decoder 15, the image decoder 16, the sub-image decoder 17, or the work memory 18.

Here, the control information such as the VMGI and the VTSI shown in FIG. 2 is temporarily recorded in the work memory 18. Further, the various information detection processing part 12A in the MPU 12 refers to the video manger menu existence information (VMGM_EXST) 101 and the video title set menu existence information (VTSM_EXST) 102, which are shown in FIG. 2, so that it can recognize the existence or not of data of the video manager menu (VMGM) and data of the video title set menu (VTSM).

The user can transmit information to the MPU 12 via the external operation device 24 such as a remote controller.

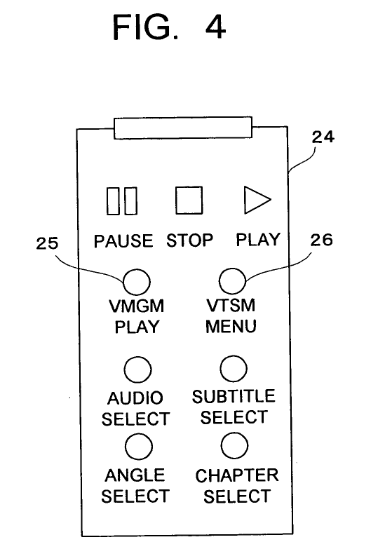

Next, an implementation example of a menu call function of the external operation device 24 will be described. FIG. 4 is a view showing an implementation example (comparative example) of the menu call function of the external operation device used in the information reproducing apparatus shown in FIG. 3.

FIG. 4 shows an example where the external operation device 24 has two buttons, i.e., a VMGM PLAY 25 and a VTSM PLAY 26 and the user presses the VMGM PLAY 25 when calling the video manager menu (VMGM) and presses the VTSM PLAY 26 when calling the video title menu (VTSM).

In this example, however, a means for notifying the user of the existence or not of the video manager menu (VMGM) and the video title set menu (VTSM) is necessary, which is disadvantageous in that the operation becomes complicated. In addition, the existence of the two buttons with similar functions tends to confuse the user.

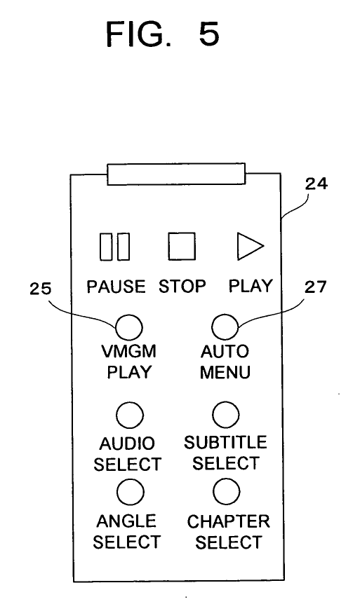

In contrast, FIG. 5 is a view showing another implementation example of a menu call function of the external operation device used in the information reproducing apparatus shown in FIG. 3. In this external operation device 24, a VMGM PLAY 25 and an automatic menu determining button 27 (hereinafter, referred to as an “AUTO MENU button 27) are provided instead of the combination of the two buttons, i.e., the VMGM PLAY 25 and the VTSM PLAY 26 shown in FIG. 4.

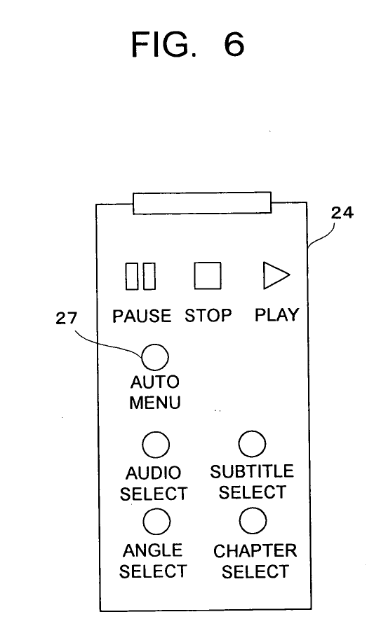

Further, FIG. 6 is a view showing still another implementation example of the menu call function of the external operation device used in the information reproducing apparatus shown in FIG. 3. FIG. 6 shows an example where only one AUTO MENU button 27 is provided instead of the combination of the two buttons, i.e., the VMGM PLAY 25 and the VTSM PLAY 26 shown in FIG. 4.

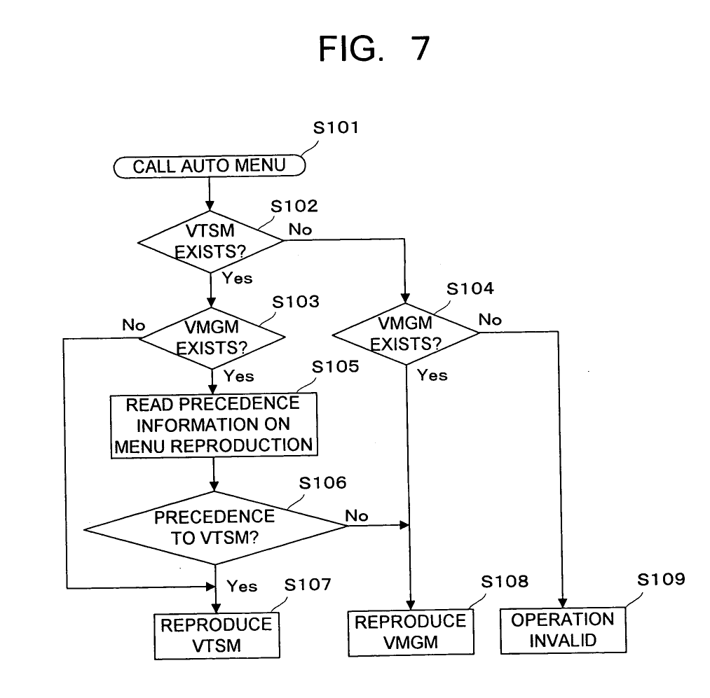

Next, an operation of menu reproduction processing in the information reproducing apparatus shown in FIG. 3 will be described with reference to FIG. 7. FIG. 7 is a flowchart showing the menu reproduction processing in the information reproducing apparatus shown in FIG. 3.

Not knowing in which of the video manager menu (VMGM) and the video title set menu (VTSM) a menu is recorded on the information recording medium (DVD Disc) 13, the user presses, for example, the AUTO MENU button 27 of the external operation device 24 shown in FIG. 5 or FIG. 6 to call displayable menus.

When the AUTO MENU button 27 of the external operation device 24 is pressed (Step S101), the various information detection processing part 12A detects the video manager menu existence information (VMGM_EXST) 101 and the video title set menu existence information (VTSM_EXST) 102 recorded in the information recording medium (DVD disc) 13 to execute the following operations based on the detection results of these pieces of existence information 101, 102.

First, the various information detection processing part 12A detects the video title set menu existence information (VTSM_EXST) 102 to determine the existence or not of the video title set menu (VTSM) (Step S102). When the video title set menu (VTSM) exists, then it detects the video manager menu existence information (VMGM_EXST) 101 to determine the existence or not of the video manager menu (VMGM) (Step S103).

When the video manager menu (VMGM) is found to exist as a result, precedence information on menu reproduction set in advance in the reproduction precedence setting part 12B, that is, information indicating which one of the video manager menu (VMGM) and the video title set menu (VTSM) is to be reproduced in precedence, is read (Step S105), and the menu that is set as one to be reproduced in precedence is reproduced (Steps S106, S107, S108). Note that to reproduce a menu means to transmit a command from the MPU 12 to the various information detecting/processing part 14 and send each data at a predetermined position in the Data Area to the audio decoder 15, the image decoder 16, or the sub-image decoder 17, where the data is thereafter processed. This also applies to the description below.

When it is judged at Step S103 that the video manager menu (VMGM) does not exist, a menu of the video title set menu (VTSM) is reproduced (Step S107).

Further, when it is judged at Step S102 that the video title set menu (VTSM) does not exist, the video manager menu existence information (VMGM_EXST) 101 is subsequently detected to determine the existence or not of the video manager menu (VMGM) (Step S104). When it is as a result judged that the video manager menu (VMGM) exists, a menu of the video manager menu (VMGM) is reproduced (Step S108), while, when it is judged that the video manager menu (VMGM) does not exist, that is, when it is judged that neither the video manager menu (VMGM) nor the video title set menu (VTSM) exists, the operation of the AUTO MENU button 27 becomes invalid (Step S109).

Next, an operation of setting the precedence information on menu reproduction will be described.

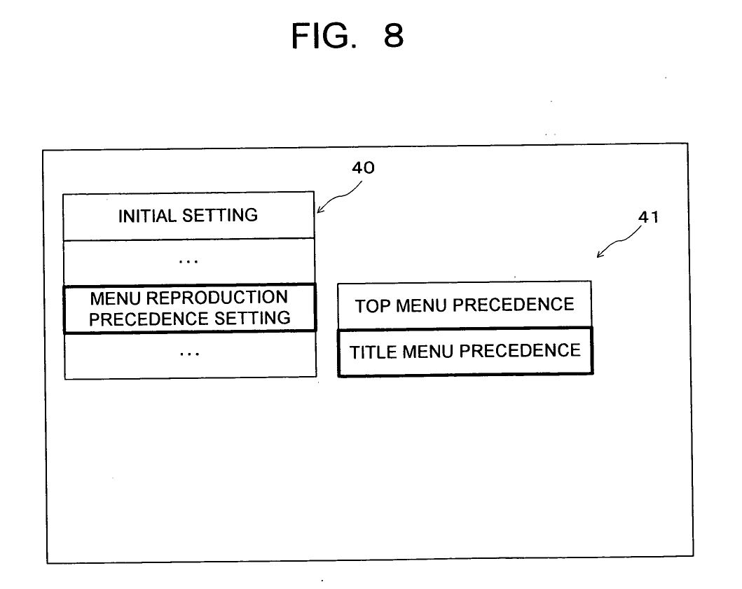

FIG. 8 is a view showing an example of a screen for setting of the precedence information on menu reproduction.

A menu 40 for initial setting of various functions of the information reproducing apparatus includes an item of “menu reproduction precedence setting”. When a user selects the “menu reproduction precedence setting” from this initial setting menu 40, a menu setting 41 on a subsequent hierarchy of the “menu reproduction precedence setting” is displayed. This menu setting 41 consists of two items of “top menu precedence” and “title menu precedence”. When the user selects the “top menu precedence” from these items, the precedent reproduction of the video manager menu (VMGM) is set, while the user's selection of the “title menu precedence” results in setting of precedent reproduction of the video title set menu (VTSM).

As described above, according to the information reproducing apparatus of this embodiment, only by pressing the AUTO MENU button 27 of the external operation device 24, it is possible to reproduce a preset menu in precedence out of the video manager menu (VMGM) and the video title set menu (VTSM), so that operability can be improved.

Next, another embodiment of the present invention will be described.

In the above-described embodiment, when it is judged in the menu reproduction processing shown in FIG. 7 that neither the video manager menu (VMGM) nor the video title set menu (VTSM) exists, the operation of the AUTO MENU button 27 becomes invalid. However, instead of thus making the operation invalid, a menu screen (OSD screen) may be displayed, the menu screen being created by the screen creating part 23 shown in FIG. 3 based on information regarding titles recorded in the information recording medium (DVD disc) 13, for example, title names, aspect ratio, kind of language, kind of angle, and the like. At this time, the screen creating part 23 obtains the information regarding the titles recorded in the information recording medium (DVD disc) 13 from the OSD display processing part 12C shown in FIG. 3 to create the menu screen (OSD screen).

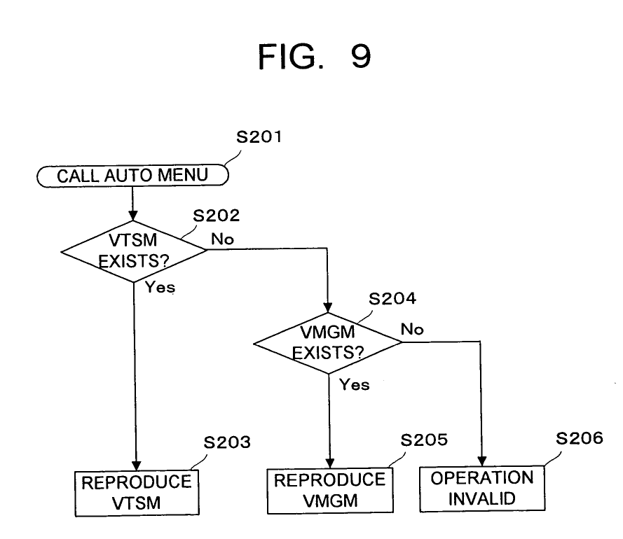

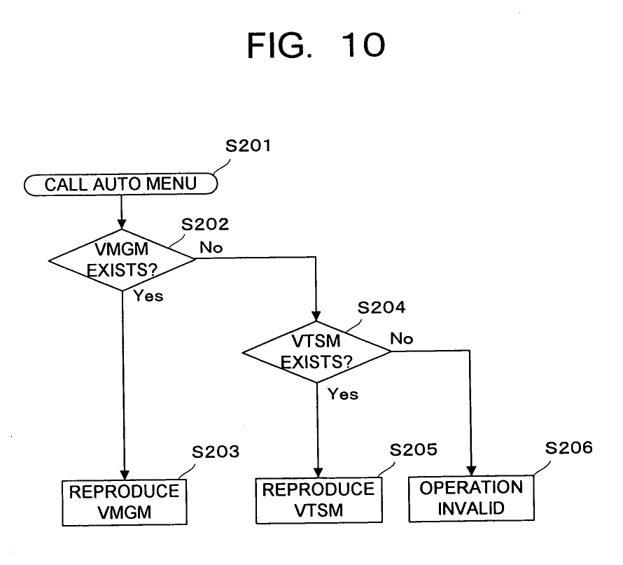

As still another embodiment, the reproduction precedence of the video manager menu (VMGM) or the video title set menu (VTSM) in the information reproducing apparatus may be fixedly predetermined in firmware instead of determining it based on the precedence information on menu reproduction set by a user. This will be described below with reference to FIG. 9 and FIG. 10.

FIG. 9 is a flowchart showing menu reproduction processing (another example) in the information reproducing apparatus shown in FIG. 3.

When the AUTO MENU button 27 of the external operation device 24 is pressed (Step S201), the video title set menu existence information (VTSM_EXST) 102 is first detected to determine the existence or not of the video title set menu (VTSM) (Step S202). When the video title set menu (VTSM) exists, the menu of the video title set menu (VTSM) is reproduced (Step S203).

When it is judged at Step S202 that the video title set menu (VTSM) does not exist, the video manager menu existence information (VMGM_EXST) 101 is subsequently detected to determine the existence or not of the video manager menu (VMGM) (Step S204). When it is judged that the video manager menu (VMGM) exists, the video manager menu (VMGM) is reproduced (Step S205), and when it is judged that the video manager menu (VMGM) does not exist, that is, when it is judged that neither the video manager menu (VMGM) nor the video title set menu (VTSM) exists, the operation of the AUTO MENU button 27 becomes invalid (Step S206).

In short, in this example, when the video title set menu (VTSM) and, the video manager menu (VMGM) are both recorded in the information recording medium (DVD disc) 13, the video title set menu (VTSM) is always reproduced in precedence.

It goes without saying that the video manager menu (VMGM) may be set as a menu to be reproduced in precedence. FIG. 10 shows a flowchart of processing in this case. Specific description of FIG. 10 is similar to that of FIG. 9, and therefore will be omitted.

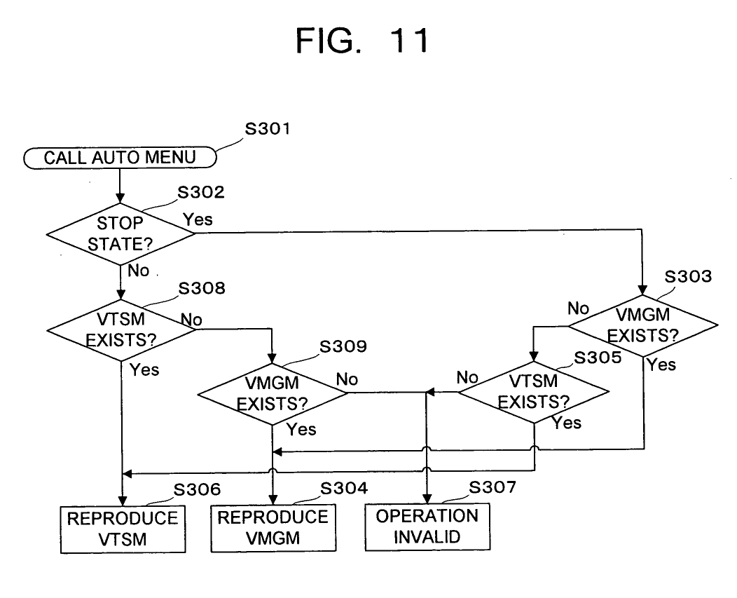

As yet another embodiment of the present invention, the precedence may be changeably given to the reproduction of the video title set menu (VTSM) or to the reproduction of the video manager menu (VMGM) according to a state of an operation currently being executed by the information reproducing apparatus. This will be described below with reference to FIG. 11.

FIG. 11 is a flowchart showing menu reproduction processing (yet another example) in the information reproducing apparatus shown in FIG. 3.

When the AUTO MENU button 27 of the external operation device 24 is pressed (Step S301), the operation state sensing part 12E in the MPU 12 shown in FIG. 3 detects the operation state of the information reproducing apparatus (Step S302).

When the operation state of the information reproducing apparatus is a stop state (YES at Step S302), the video manager menu existence information (VMGM-EXST) 101 is detected to determine the existence or not of the video manager menu (VMGM) (Step S303). When the video manager menu (VMGM) exists, the menu of the video manager menu (VMGM) is reproduced (Step S304).

When it is judged at Step S303 that the video manager menu (VMGM) does not exist, the video title set menu existence information (VTSM_EXST) 102 is subsequently detected to determine the existence or not of the video title set menu (VTSM) (Step S305). When it is judged that the video title set menu (VTSM) exists, the menu of the video title set menu (VTSM) is reproduced (Step S306). When it is judged that the video title set menu (VTSM) does not exist, that is, when it is judged that neither the video manager menu (VMGM) nor the video title set menu (VTSM) exists, the operation of the AUTO MENU button 27 becomes invalid (Step S307).

On the other hand, when the operation state of the information reproducing apparatus is a state other than the stop state, the video title set menu existence information (VTSM_EXST) 102 is detected to determine the existence or not of the video title set menu (VTSM) (Step S308). When it is judged that the video title set menu (VTSM) exists, the menu of the video title set menu (VTSM) is reproduced (Step S306). When the video title set menu (VTSM) does not exist, the video manager menu existence information (VMGM_EXST) 101 is detected to determine the existence or not of the video manager menu (VMGM) (Step S309). When the video manager menu (VMGM) exists, the menu of the video manager menu (VMGM) is reproduced (Step S304). When the video manager menu (VMGM) does not exist, that is, when it is judged that neither the video manager menu (VMGM) nor the video title set menu (VTSM) exists, the operation of the AUTO MENU button 27 becomes invalid (Step S307).

As described above, in this embodiment, when it is detected that the operation state is the stop state, the video manager menu can be reproduced in precedence, and when it is detected that the operation state is a state other than the stop state, the video title set menu can be reproduced in precedence.

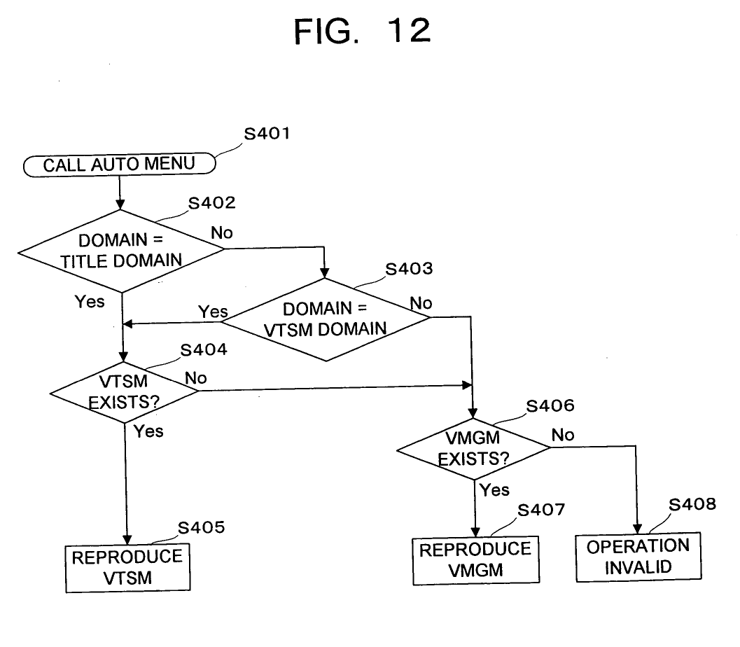

As yet another embodiment of the present invention, the reproduction precedence of the video title set menu (VTSM) or the video manager menu (VMGM) may be changeably set according to a domain as a target of reproduction being currently executed in the information reproducing apparatus. This will be described below with reference to FIG. 12.

FIG. 12 is a flowchart showing menu reproduction processing (yet another example) in the information reproducing apparatus shown in FIG. 3.

When the AUTO MENU button 27 of the external operation device 24 is pressed (Step S401), the domain detection processing part 12D in the MPU 12 shown in FIG. 3 detects a domain as a reproduction target of the information reproducing apparatus (Steps S402, S403). When the detected domain is a title domain (YES at Step S402) or a VTSM domain (YES at Step S403), the existence or not of the video title set menu (VTSM) is judged (Step S404). When it is judged that the video title set menu (VTSM) exists, the menu of the video title set menu (VTSM) is reproduced (Step S405).

When the detected domain is neither the title domain nor the VTSM domain (NO at Step S403), or when it is judged at Step S404 that the video title set menu (VTSM) does not exist, the existence or not of the video manager menu (VMGM) is judged (Step S406). When the video manager menu (VMGM) exists, the video manager menu (VMGM) is reproduced in precedence (Step S407), and otherwise, the operation becomes invalid (Step S408).

It should be noted that the present invention is not limited to the examples illustrated above, and various changes can of course be made within a range not departing from the spirit of the present invention. In the above-described embodiments, the information reproducing apparatus was described, but the present invention is applicable also to an information recording/reproducing apparatus.

It should be understood that the present invention is not limited to specific forms described with illustration here, but all changes which come within the range of the following claims are intended to be embraced therein.

1. An information reproducing apparatus that reproduces information from an information recording medium in which information including a video manager menu and a video title set menu is recorded, the information reproducing apparatus comprising:
a command input part inputting a common command for reproducing the video manager menu or the video title set menu;
a detecting part which detects existence information of the video manager menu and existence information of the video title set menu from information read from the information recording medium; and
a menu reproducing part which reproduces, in precedence, a predetermined menu that is found recorded based on the detected existence information, out of the video manager menu and the video title set menu, when the common command is inputted from the command input part.

2. An information reproducing apparatus as set forth in claim 1, further comprising a setting part that sets which menu is to be reproduced in precedence out of the video manager menu and the video title set menu.

3. An information reproducing apparatus as set forth in claim 1, further comprising an operation state detecting part detecting whether a current state is a stop state or not,
wherein the menu reproducing part reproduces the video manager menu in precedence when the operation state detecting part detects that the current state is the stop state, while reproducing the video title set menu in precedence when the operation state detecting part detects that the current state is a state other than the stop state.

4. An information reproducing apparatus as set forth in claim 1, further comprising a domain detecting part detecting a domain under reproduction,
wherein the menu reproducing part reproduces the video title set menu in precedence when the domain detecting part detects that one of a title domain and a video title set menu domain is under reproduction, while reproducing the video manager menu in precedence in other cases.

5. An information reproducing method of reproducing information from an information recording medium in which information including a video manager menu and a video title set menu is recorded, the information reproducing method, comprising:
inputting a common command for reproducing the video manager menu or the video title set menu;
detecting existence information of the video manager menu and existence information of the video title set menu from information read from the information recording medium; and
reproducing, in precedence, a predetermined menu that is found recorded based on the detected existence information, out of the video manager menu and the video title set menu, when the common command is inputted.

6. An information reproducing method as set forth in claim 5, further comprising setting one of the video manager menu and the video title set menu as a menu to be reproduced in precedence,
wherein the predetermined menu is a menu corresponding to the set menu.

7. An information reproducing method as set forth in claim 5, further comprising detecting whether a current state is a stop state or not,
wherein the predetermined menu is the video manager menu when it is detected in the detection of the stop state or not that the current state is the stop state, and is the video title set menu when it is detected in the detection of the stop state or not that the current state is a state other than the stop state.

8. An information reproducing method as set forth in claim 5, further comprising detecting a domain under reproduction,
wherein the predetermined menu is the video title set menu when it is detected in the detection of the domain under reproduction that one of a title domain and a video title set menu domain is under reproduction, and is the video manager menu in other cases.
